(19) United States
(12) Patent Application Publication
(10) Pub. No.: US 2025/0392143 A1
(43) Pub. Date: Dec. 25, 2025

(54) Current Interruption Circuit and Current Interruption System

(71) Applicant: Yazaki Corporation, Tokyo (JP)

(72) Inventor: Yasunori Kawaguchi, Shizuoka (JP)

(21) Appl. No.: 19/208,819

(22) Filed: May 15, 2025

(30) Foreign Application Priority Data
Jun. 19, 2024 (JP) 2024-099026

(51) Int. Cl. H02J 7/00; H01H 39/00

(52) U.S. Cl. CPC H02J 7/0031; H01H 39/006; H02J 7/00304; H02J 7/0047; H01H 2039/008

(57) ABSTRACT

A current interruption circuit includes a first switch and a second switch provided on both sides of a first resistor, which is enclosed within an ignition fuse and is burned out due to heat upon ignition, the first resistor being energized when both switches are turned on, a first current sensor and a second current sensor configured to detect a current in a current path in which the ignition fuse is provided, a first overcurrent determination circuit configured to determine an overcurrent based on an output of the first current sensor, and a second overcurrent determination circuit configured to determine an overcurrent based on an output of the second current sensor. The first switch is turned on based on a determination result of the first overcurrent determination circuit. The second switch is turned on based on a determination result of the second overcurrent determination circuit.

### CROSS-REFERENCE TO RELATED APPLICATIONS

This application is based on and claims priority under 35 USC 119 from Japanese Patent Application No. 2024-099026 filed on Jun. 19, 2024, the entire content of which is incorporated herein by reference.

### TECHNICAL FIELD

The present disclosure relates to a current interruption circuit and a current interruption system.

### BACKGROUND ART

As the above current interruption circuit, a power supply system disclosed in JP2017-103949A has been proposed. According to the power supply system in JP2017-103949A, a fuse is blown when an overcurrent flows through a main battery, which is a drive source of a vehicle. It takes time for a fuse to blow after an overcurrent flows. In recent years, due to an increase in current of a battery electric vehicle (BEV), there is a need to immediately interrupt the current when an overcurrent occurs. Therefore, instead of the fuse, an ignition fuse has been proposed that ignites an explosive in response to receiving an output of an overcurrent detection signal to cut off a current path at high speed as disclosed in, for example, JP2020-136055A.

When the ignition fuse is blown in a normal running state, the vehicle stops. For this reason, the ignition fuse is required to reliably blow when an overcurrent occurs and not blow in a normal state.

The present disclosure has been made in view of the above circumstances, and an object thereof is to provide a current interruption circuit and a current interruption system capable of accurately blowing an ignition fuse when an overcurrent occurs and reducing erroneous blowing of the ignition fuse in a normal state in which no overcurrent occurs.

### SUMMARY OF INVENTION

According to the present disclosure, a current interruption circuit includes a first switch and a second switch provided on both sides of a first resistor, which is enclosed within an ignition fuse and is burned out due to heat upon ignition, the first resistor being energized when both switches are turned on, a first current sensor and a second current sensor configured to detect a current in a current path in which the ignition fuse is provided, a first overcurrent determination circuit configured to determine an overcurrent based on an output of the first current sensor, and a second overcurrent determination circuit configured to determine an overcurrent based on an output of the second current sensor. The first switch is turned on based on a determination result of the first overcurrent determination circuit. The second switch is turned on based on a determination result of the second overcurrent determination circuit.

According to the present disclosure, a current interruption system includes the above current interruption circuit further including a second resistor and a diode connected in series between a first power supply voltage and a connection point of the first resistor and the first switch, a third resistor connected between a second power supply voltage and a connection point of the first resistor and the second switch, a dummy voltage output circuit configured to output a dummy voltage corresponding to an overcurrent, a third switch configured to switch an input to the first overcurrent determination circuit between the output of the first current sensor and the dummy voltage output by the dummy voltage output circuit, and a fourth switch configured to switch an input to the second overcurrent determination circuit between the output of the second current sensor and the dummy voltage output by the dummy voltage output circuit, and a controller configured to determine a failure based on a voltage between the second resistor and the first resistor or a voltage between the third resistor and the first resistor, in each case in which the third switch is switched to a first current sensor side and the fourth switch is switched to a second current sensor side, or the third switch is switched to a dummy voltage output circuit side and the fourth switch is switched to the second current sensor side, or the third switch is switched to the first current sensor side and the fourth switch is switched to the dummy voltage output circuit side.

According to the present disclosure, a current interruption system includes the above current interruption circuit, and a controller configured to turn on an active signal. The first switch and the second switch are not turned on while the active signal is off.

The current interruption circuit and the current interruption system according to the present disclosure have an advantage that erroneous blowing of a fuse can be reduced.

The present disclosure has been briefly described above. Further, the details of the present disclosure can be clarified by reading modes (hereinafter, referred to as “embodiments”) for carrying out the disclosure described below with reference to the accompanying drawings.

### BRIEF DESCRIPTION OF DRAWINGS

FIG. 1 is a block diagram illustrating an example of a current interruption system according to a first embodiment of the present disclosure;

FIG. 2 is a graph illustrating output characteristics of a current sensor 241 illustrated in FIG. 1;

FIG. 3 is a graph illustrating output characteristics of a current sensor 242 illustrated in FIG. 1;

FIG. 4 is a circuit diagram illustrating details of overcurrent determination circuits 251, 252 illustrated in FIG. 1;

FIG. 5 is a perspective view illustrating an example of the current sensors 241, 242 illustrated in FIG. 1;

FIG. 6 is a flowchart illustrating a processing procedure in failure determination processing of an MCU illustrated in FIG. 1;

FIG. 7 is a table illustrating details of failure determination in S4, S7, and S8 illustrated in FIG. 6;

FIG. 8 is a circuit diagram illustrating an overcurrent determination circuit according to a second embodiment;

FIG. 9 is a circuit diagram illustrating details of a positive-side sticking determination circuit and a negative-side sticking determination circuit illustrated in FIG. 8;

FIG. 10 is a circuit diagram illustrating an overcurrent determination circuit according to a third embodiment; and

FIG. 11 is a block diagram illustrating an example of a current interruption system according to a fourth embodiment.

### DESCRIPTION OF EMBODIMENTS

Specific embodiments of the present disclosure will be described below with reference to the drawings.

### First Embodiment

A current interruption system 1 according to the present disclosure blows an ignition fuse provided in a current path through which a discharge current (positive direction) and a charge current (negative direction) of a battery, which is a drive source of a vehicle, flow. The current interruption system 1 includes a current interruption circuit 2 and a microcomputer 3 (hereinafter, abbreviated as “MCU 3”) that controls the current interruption circuit 2. The current interruption circuit 2 includes a power supply circuit 21 that generates 12 V and a low dropout (LDO) regulator 22 that generates 5 V.

The current interruption circuit 2 includes an IPD 231 (first switch), an IPD 232 (second switch), a current sensor 241 (first current sensor), a current sensor 242 (second current sensor), an overcurrent determination circuit 251 (first overcurrent determination circuit), an overcurrent determination circuit 252 (second overcurrent determination circuit), AND circuits 273, 274, and a failure determination circuit 28.

The ignition fuse includes a thin plate conductor connected to the current path, an igniter having a resistor Rp (first resistor), and a cutter. When the resistor Rp is energized, an explosive of the igniter is ignited by heat, and an explosion occurs. The cutter cuts the thin plate conductor by a pressure of the explosion. The resistor Rp is burned out by the explosion. The intelligent power devices (IPDs) 231, 232 are provided on both sides of the resistor Rp, and when both are turned on, the resistor Rp is energized. The IPD 231 is connected between the power supply circuit 21 and one end of the resistor Rp, and supplies 12 V to the one end of the resistor Rp when turned on. The IPD 232 is connected between ground and the other end of the resistor Rp, and supplies 0 V to the other end of the resistor Rp when turned on. When the IPDs 231, 232 are turned on, 12 V is applied to both ends of the resistor Rp, the resistor Rp is energized, and the ignition fuse is blown.

The current sensors 241, 242 each detect a current flowing through a current path in which the ignition fuse is provided. The ignition fuse is provided in a current path through which a discharge current and a charge current of the battery flow. The current sensors 241, 242 each output an analog signal with good responsiveness. The current sensors 241, 242 are each, for example, a Hall IC type current sensor that measures a magnetic flux density of a current and outputs a voltage, and a shunt type current sensor that measures a voltage generated between resistors by a current flowing through a shunt resistor and outputs a voltage. In the present embodiment, the current sensors 241, 242 are each, for example, a Hall IC type current sensor and can detect a current of +2000 A to −2000 A.

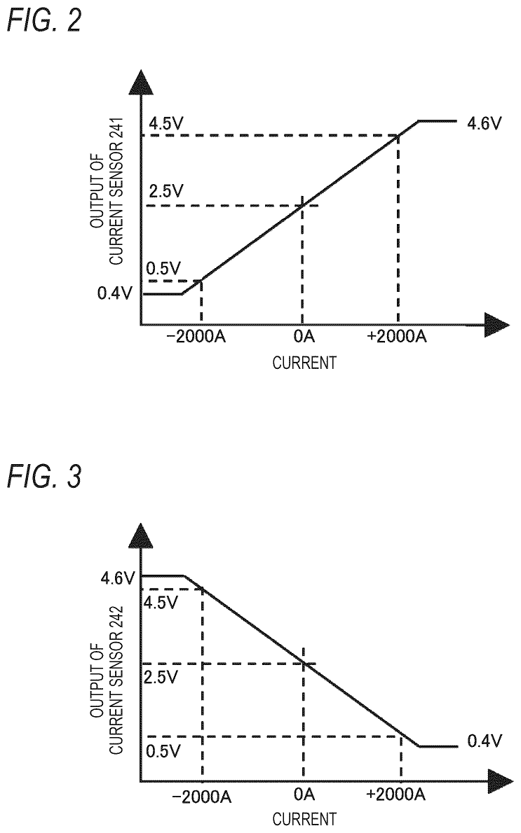

As illustrated in FIG. 2, an output of the current sensor 241 increases in response to an increase in current flowing through the current path. As illustrated in FIG. 3, an output of the current sensor 242 decreases in response to an increase in current flowing through the current path. Further, as illustrated in FIG. 2, the output of the current sensor 241 is clamped to a first clamp voltage (for example, 4.6 V) when a large current flows in the positive direction in a normal state, and is clamped to a second clamp voltage (for example, 0.4 V) when a large current flows in the negative direction. As illustrated in FIG. 3, the output of the current sensor 242 is clamped to the second clamp voltage (0.4 V) when a large current flows in the positive direction in the normal state, and is clamped to the first clamp voltage (4.6 V) when a large current flows in the negative direction. That is, the outputs of the current sensors 241, 242 vary in a range of 0.4 V or more and 4.6 V or less in the normal state. On the other hand, when a failure such as a short circuit or an open circuit occurs, the outputs of the current sensors 241, 242 stick to a first power supply voltage (5 V) or a second power supply voltage (0 V).

The overcurrent determination circuit 251 is a circuit that determines an overcurrent based on the output of the current sensor 241. In the present embodiment, the overcurrent determination circuit 251 determines an overcurrent of, for example, 1300 A or more in both the positive direction and the negative direction. When the output of the current sensor 241 exceeds a first threshold (for example, 4.3 V) or falls below a second threshold (for example, 0.7 V), the overcurrent determination circuit 251 detects an overcurrent and outputs an H-level overcurrent signal S11. When the output of the current sensor 241 is equal to or smaller than the first threshold (4.3 V) and equal to or greater than the second threshold (0.7 V), the overcurrent determination circuit 251 outputs an L-level overcurrent signal S11 indicating normality.

The overcurrent determination circuit 252 is a circuit that determines an overcurrent based on the output of the current sensor 242. Similarly to the overcurrent determination circuit 251, when the output of the current sensor 242 exceeds the first threshold (4.3 V) or falls below the second threshold (0.7 V), the overcurrent determination circuit 252 detects an overcurrent and outputs an H-level overcurrent signal S12. When the output of the current sensor 242 is equal to or smaller than the first threshold (4.3 V) and equal to or greater than the second threshold (0.7 V), the overcurrent determination circuit 252 outputs an L-level overcurrent signal S12 indicating normality.

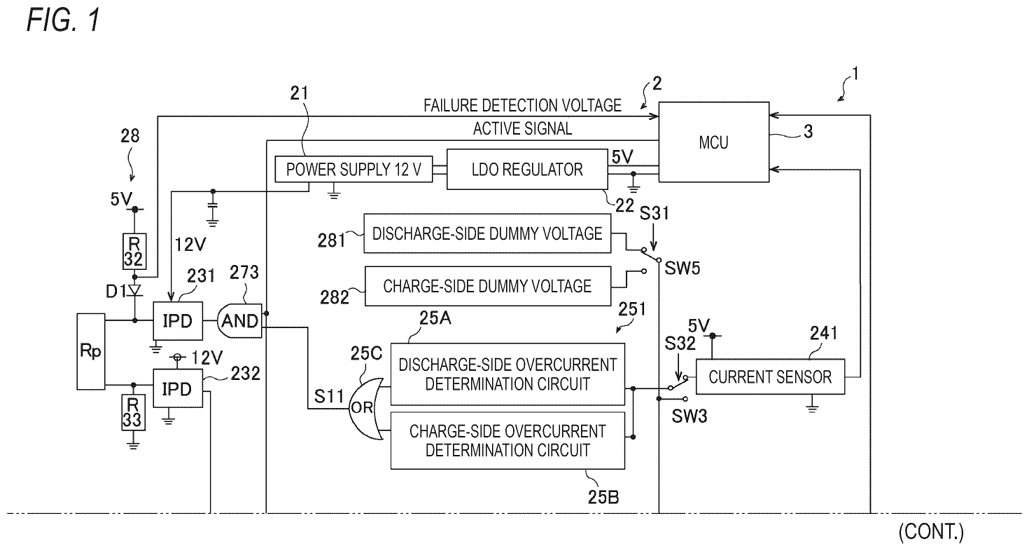

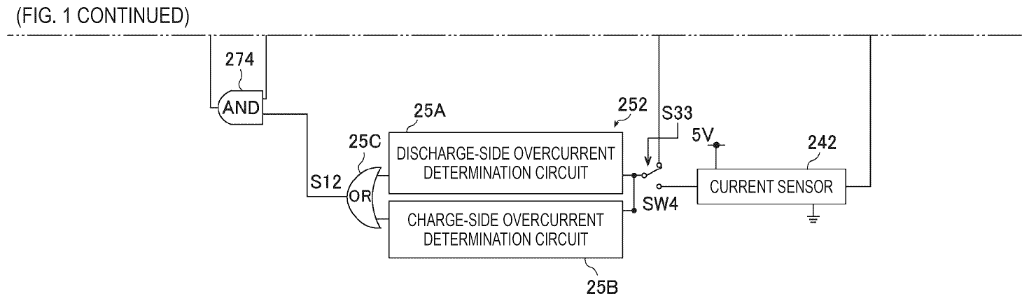

Next, details of the overcurrent determination circuits 251, 252 will be described. Since the overcurrent determination circuits 251, 252 have the same circuit configuration, the overcurrent determination circuit 251 will be described as a representative. As illustrated in FIG. 1, the overcurrent determination circuit 251 includes a discharge-side overcurrent determination circuit 25A, a charge-side overcurrent determination circuit 25B, and an OR circuit 25C. When the output of the current sensor 241 exceeds the first threshold (4.3 V), the discharge-side overcurrent determination circuit 25A determines an overcurrent in the positive direction (discharge direction) and outputs an H-level signal. When the output of the current sensor 241 falls below the second threshold (0.7 V), the charge-side overcurrent determination circuit 25B determines an overcurrent in the negative direction (charge direction) and outputs an H-level signal. The OR circuit 25C outputs an H-level overcurrent signal S11 when one of the discharge-side overcurrent determination circuit 25A and the charge-side overcurrent determination circuit 25B outputs an H-level signal indicating an overcurrent.

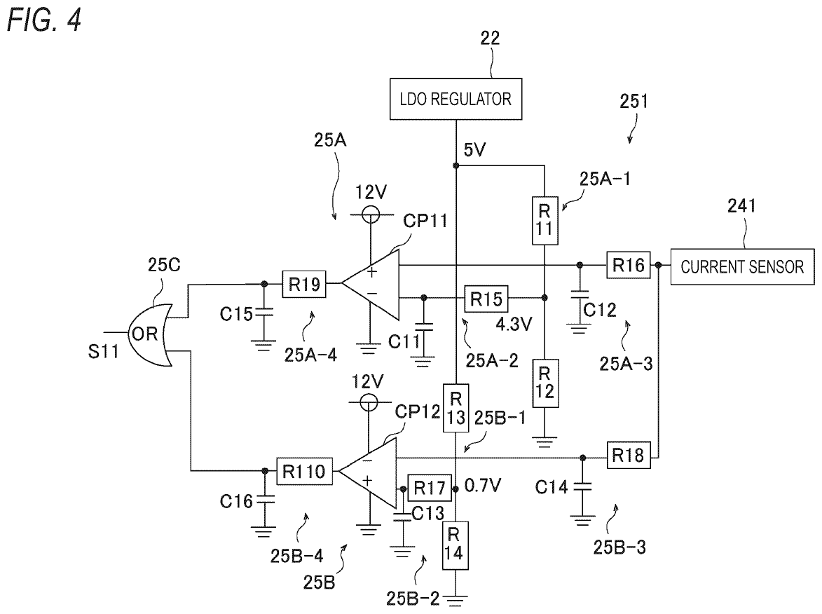

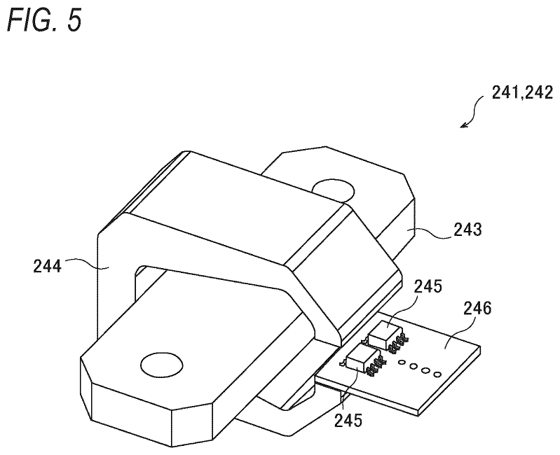

Next, examples of the discharge-side overcurrent determination circuit 25A and the charge-side overcurrent determination circuit 25B will be described with reference to FIG. 4. As illustrated in the drawing, the discharge-side overcurrent determination circuit 25A includes a first threshold output circuit 25A-1, a comparator CP11 (first comparator), and low-pass filters 25A-2 to 25A-4. The charge-side overcurrent determination circuit 25B includes a second threshold output circuit 25B-1, a comparator CP12 (first comparator), and low-pass filters 25B-2 to 25B-4.

The first threshold output circuit 25A-1 outputs the first threshold (4.3 V). The first threshold output circuit 25A-1 includes resistors R11, R12 connected in series between an output of the LDO regulator 22 and ground. The first threshold output circuit 25A-1 outputs a voltage obtained by dividing 5 V by the resistors R11, R12 as the first threshold (4.3 V).

The output of the current sensor 241 is input to a non-inverting input of the comparator CP11 via the low-pass filter 25A-3, and the first threshold (4.3 V) is input to an inverting input of the comparator CP11 via the low-pass filter 25A-2. The comparator CP11 compares the output of the current sensor 241 with the first threshold (4.3 V), and outputs an H-level signal when the output of the current sensor 241 is greater than the first threshold (4.3 V). The comparator CP11 outputs an L-level signal when the output of the current sensor 241 is equal to or smaller than the first threshold (4.3 V).

The second threshold output circuit 25B-1 outputs the second threshold (0.7 V). The second threshold output circuit 25B-1 includes resistors R13, R14 connected in series between the output of the LDO regulator 22 and ground. The second threshold output circuit 25B-1 outputs a voltage obtained by dividing 5 V by the resistors R13, R14 as the second threshold (0.7 V).

The output of the current sensor 241 is input to an inverting input of the comparator CP12 via the low-pass filter 25B-3, and the second threshold (0.7 V) is input to a non-inverting input of the comparator CP12 via the low-pass filter 25B-2. The comparator CP12 compares the output of the current sensor 241 with the second threshold (0.7 V), and outputs an H-level signal when the output of the current sensor 241 is smaller than the second threshold (0.7 V). The comparator CP12 outputs an L-level signal when the output of the current sensor 241 is equal to or greater than the second threshold (0.7 V).

The low-pass filter 25A-2 (first low-pass filter) is provided between the first threshold output circuit 25A-1 and an input of the comparator CP11. The low-pass filter 25A-2 includes a resistor R15 connected between a connection point of the resistors R11, R12 and the inverting input of the comparator CP11, and a capacitor (capacitance) C11 connected between ground and a connection point of the resistor R15 and the comparator CP11. The low-pass filter 25A-2 removes high-frequency noise at or above a cutoff frequency from an output of the first threshold output circuit 25A-1. Since the cutoff frequency is determined by values of the resistor R15 and the capacitor C11, the cutoff frequency is set within a range that does not sacrifice a response speed.

The low-pass filter 25A-3 (second low-pass filter) is provided between the current sensor 241 and the input of the comparator CP11. The low-pass filter 25A-3 includes a resistor R16 connected between the current sensor 241 and the non-inverting input of the comparator CP11, and a capacitor (capacitance) C12 connected between ground and a connection point of the resistor R16 and the comparator CP11. The low-pass filter 25A-3 removes high-frequency noise at or above a cutoff frequency from the output of the current sensor 241. Since the cutoff frequency is determined by values of the resistor R16 and the capacitor C12, the cutoff frequency is set within a range that does not sacrifice the response speed.

In the present embodiment, to prevent the first threshold (4.3 V) from falling earlier than the output of the current sensor 241 when the LDO regulator 22 is powered off, the value of the capacitor C11 is set to be greater than that of the capacitor C12.

The low-pass filter 25B-2 (third low-pass filter) is provided between the second threshold output circuit 25B-1 and an input of the comparator CP12. The low-pass filter 25B-2 includes a resistor R17 connected between a connection point of the resistors R13, R14 and the non-inverting input of the comparator CP11, and a capacitor (capacitance) C13 connected between ground and a connection point of the resistor R17 and the comparator CP12. The low-pass filter 25B-2 removes high-frequency noise at or above a cutoff frequency from an output of the second threshold output circuit 25B-1. Since the cutoff frequency is determined by values of the resistor R17 and the capacitor C13, the cutoff frequency is set within a range that does not sacrifice the response speed.

The low-pass filter 25B-3 (fourth low-pass filter) is provided between the current sensor 241 and the input of the comparator CP12. The low-pass filter 25B-3 includes a resistor R18 connected between the current sensor 241 and the inverting input of the comparator CP12, and a capacitor (capacitance) C14 connected between ground and a connection point of the resistor R18 and the comparator CP12. The low-pass filter 25B-3 removes high-frequency noise at or above a cutoff frequency from the output of the current sensor 241. Since the cutoff frequency is determined by values of the resistor R18 and the capacitor C14, the cutoff frequency is set within a range that does not sacrifice the response speed.

In the present embodiment, to prevent the output of the current sensor 241 from falling earlier than the second threshold (0.7 V) when the LDO regulator 22 is powered off, the value of the capacitor C14 is set to be greater than that of the capacitor C13.

The low-pass filter 25A-4 is provided between an output of the comparator CP11 and an input of the OR circuit 25C. The low-pass filter 25A-4 includes a resistor R19 connected between the comparator CP11 and the input of the OR circuit 25C, and a capacitor (capacitance) C15 connected between ground and a connection point between the resistor R19 and the input of the OR circuit 25C. The low-pass filter 25A-4 removes high-frequency noise at or above a cutoff frequency from the output of the comparator CP11. Since the cutoff frequency is determined by values of the resistor R19 and the capacitor C15, the cutoff frequency is set within a range that does not sacrifice the response speed.

The low-pass filter 25B-4 is provided between an output of the comparator CP12 and the OR circuit 25C. The low-pass filter 25B-4 includes a resistor R110 connected between the comparator CP12 and the input of the OR circuit 25C, and a capacitor (capacitance) C16 connected between ground and a connection point between the resistor R110 and the input of the OR circuit 25C. The low-pass filter 25B-4 removes high-frequency noise at or above a cutoff frequency from the output of the comparator CP12. Since the cutoff frequency is determined by values of the resistor R110 and the capacitor C16, the cutoff frequency is set within a range that does not sacrifice a response speed.

The output of the comparator CP11 is input to the OR circuit 25C via the low-pass filter 25A-4, and the output of the comparator CP12 is input to the OR circuit 25C via the low-pass filter 25B-4. Therefore, the OR circuit 25C outputs an H-level overcurrent signal S11 when the output of the current sensor 241 exceeds the first threshold (4.3 V) or falls below the second threshold (0.7 V). When the output of the current sensor 241 is equal to or smaller than the first threshold (4.3 V) and equal to or greater than the second threshold (0.7 V), the OR circuit 25C outputs an L-level overcurrent signal S11.

The overcurrent determination circuit 252 can be described by replacing the “overcurrent determination circuit 251” with the “overcurrent determination circuit 252”, replacing the “current sensor 241” with the “current sensor 242”, and replacing the “overcurrent signal S11” with the “overcurrent signal S12” in the above description of the overcurrent determination circuit 251.

As illustrated in FIG. 1, the above overcurrent signal S11 and an active signal from the MCU 3 are input to the AND circuit 273. The overcurrent signal S12 and the active signal from the MCU 3 are input to the AND circuit 274.

Next, a configuration of the failure determination circuit 28 will be described. The above failure determination circuit 28 is a circuit that determines failures in the overcurrent determination circuit 251, the IPDs 231, 232, and the resistor Rp. The failure determination circuit 28 includes a resistor R32, a diode D1, a resistor R33, a discharge-side dummy voltage output circuit 281, a charge-side dummy voltage output circuit 282, a switch SW3 (third switch), a switch SW4 (fourth switch), and a switch SW5.

The resistor R32 and the diode D1 are connected in series between 5 V and a connection point of the resistor Rp and IPD 231. The diode D1 is connected in a forward direction from 5 V toward a connection point of the resistor Rp and the IPD 231. The resistor R33 is connected between ground and a connection point of the resistors Rp and the IPD 232.

The discharge-side dummy voltage output circuit 281 outputs a dummy voltage (4.5 V) corresponding to an overcurrent in the positive direction (discharge direction). The charge-side dummy voltage output circuit 282 outputs a dummy voltage (0.5 V) corresponding to an overcurrent in the negative direction (charge direction). The discharge-side dummy voltage output circuit 281 and the charge-side dummy voltage output circuit 282 are composed of voltage divider resistors connected in series between the output (5 V) of the LDO regulator 22 and ground, and respectively output voltages obtained by dividing 5 V by the voltage divider resistors as a discharge-side dummy voltage (4.5 V) and a charge-side dummy voltage (0.5 V).

The switch SW5 is a switch for selecting one of the dummy voltage (4.5 V) output by the discharge-side dummy voltage output circuit 281 and the dummy voltage (0.5 V) output by the charge-side dummy voltage output circuit 282. The switch SW3 switches an input to the overcurrent determination circuit 251 between the output of the current sensor 241 and one of the dummy voltage (4.5 V) and the dummy voltage (0.5 V) selected by the switch SW5. The switch SW4 switches an input to the overcurrent determination circuit 252 between the output of the current sensor 242 and one of the dummy voltage (4.5 V) and the dummy voltage (0.5 V) selected by the switch SW5.

A voltage at a connection point between the resistor R32 and the diode D1 is input to the MCU 3 as a failure detection voltage. The MCU 3 outputs an overcurrent switching signal S31 and forced interruption signals S32, S33 to the switches SW3 to SW5 to control the switches SW3 to SW5. The MCU 3 detects a failure based on the failure detection voltage output while the dummy voltage (4.5 V) or the dummy voltage (0.5 V) is input to the overcurrent determination circuits 251, 252. When the MCU 3 detects a failure based on the failure detection voltage, the MCU 3 stops outputting the active signal.

The current interruption circuit 2 that constitutes the above current interruption system 1 is mounted on a substrate on which the current sensors 241, 242 are mounted. More specifically, when the current sensors 241, 242 are of the Hall IC type, it is as illustrated in FIG. 5. The current sensors 241, 242 each include a bus bar 243 connected to a current path, a core 244 that surrounds the bus bar 243, and a hole IC 245 disposed in a gap of the core 244.

One bus bar 243 and one core 244 are provided (in common) for the two current sensors 241, 242. The hole IC 245 is provided for each of the two current sensors 241, 242. The IPDs 231, 232, the overcurrent determination circuits 251, 252, and the failure determination circuit 28 that constitute the current interruption circuit 2 are mounted on a substrate 246 on which the hole IC 245 is mounted. For example, a microcomputer for monitoring a battery may be used as the MCU 3. The MCU 3 is not mounted on the substrate 246.

According to the above configuration, there is no need to separately provide a substrate for the current sensors 241, 242 and a substrate for the IPDs 231, 232, the overcurrent determination circuits 251, 252, and the failure determination circuit 28, and the number of components and size can be reduced.

Next, an operation of the current interruption system 1 having the above configuration will be described. When an ignition switch of the vehicle is turned on and the power is turned on, the MCU 3 sets the active signal to an L-level (OFF) for a certain period until outputs of the power supply circuit 21 and the LDO regulator 22 are stable after the power is turned on. Accordingly, outputs of the AND circuits 273, 274 are at the L-level, and the IPDs 231, 232 are not turned on while the active signal is at the L-level.

If the power supply is not stable, the first threshold (4.3 V) and the second threshold (0.7 V) generated by the overcurrent determination circuits 251, 252 are not accurate. This may cause the overcurrent determination circuits 251, 252 to make an erroneous determination. In the present embodiment, after the power is turned on, the active signal is set to the L-level until the power is stable, so that the IPDs 231, 232 are not turned off during that time. Therefore, erroneous determinations by the overcurrent determination circuits 251, 252 can be reduced, and erroneous blowing of the ignition fuse can be reduced.

Next, a state after the active signal is at the H-level will be described. When the overcurrent determination circuits 251, 252 determine an overcurrent and output H-level overcurrent signals S11, S12, the IPDs 231, 232 are turned on. Accordingly, the resistor Rp is made conductive, the ignition fuse is blown, and a large current can be interrupted.

When the overcurrent determination circuit 251 outputs the H-level overcurrent signal S11 and the overcurrent determination circuit 252 outputs the L-level overcurrent signal S12, the IPD 231 is turned on but the IPD 232 is not turned on. Therefore, the resistor Rp is not energized, and the ignition fuse is not blown. Conversely, when the overcurrent determination circuit 252 outputs the H-level overcurrent signal S12 and the overcurrent determination circuit 251 outputs the L-level overcurrent signal S11, the IPD 232 is turned on but the IPD 231 is not turned on. Also in this case, the resistor Rp is not energized, and the ignition fuse is not blown.

When the current interruption circuit 2 is normal and a large current flows through the current path, the two overcurrent determination circuits 251, 252 output the H-level overcurrent signals S11, S12. As described above, when only one of the overcurrent determination circuits 251, 252 determines an overcurrent and the other does not determine an overcurrent, it is highly likely that some abnormality occurs in the current interruption circuit 2 and no large current flows through the current path. In the present embodiment, the IPD 231 is turned on when the overcurrent determination circuit 251 determines an overcurrent, and the IPD 232 is turned on when the overcurrent determination circuit 252 determines an overcurrent. That is, by energizing the resistor Rp only when both of the two overcurrent determination circuits 251, 252 determine an overcurrent, the ignition fuse can be accurately blown when the overcurrent occurs, and erroneous blowing of the ignition fuse in a normal state, in which no overcurrent occurs, can be reduced.

According to the above embodiment, as illustrated in FIGS. 2 and 3, the two current sensors 241, 242 have different changes in output in response to an increase in current. Therefore, even if noise from the same noise source is superimposed on the outputs of the current sensors 241, 242, the ways in which the noise is superimposed are different. Therefore, even if one of the overcurrent determination circuits 251, 252 determines an overcurrent due to noise, it is highly likely that the other does not determine an overcurrent, and thus erroneous blowing of the ignition fuse can be reduced.

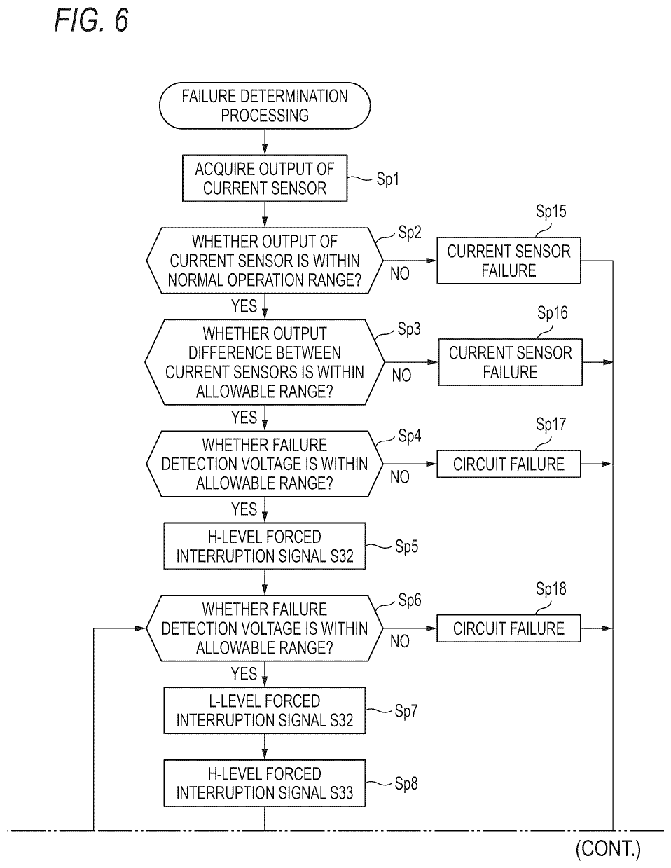

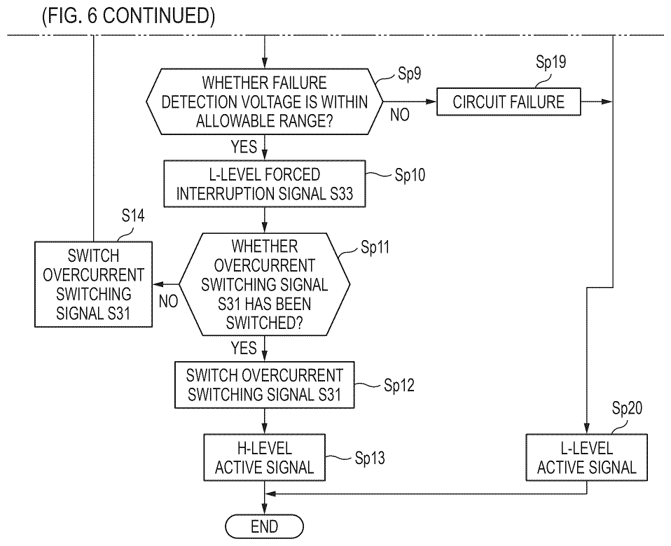

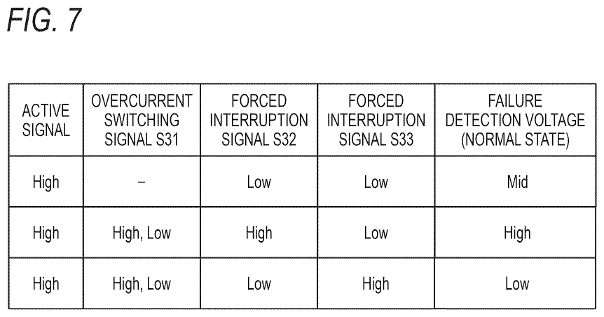

Next, failure determination processing using the failure determination circuit 28 performed by the MCU 3 will be described with reference to FIGS. 6 and 7. This failure determination processing is performed at startup, shutdown, or at regular intervals. The active signal is at the H-level. First, the MCU 3 acquires the outputs of the current sensors 241, 242 (Sp1). Next, the MCU 3 determines whether each of the outputs (digital values) of the current sensors 241, 242 is within a normal operation range (Sp2). In the present embodiment, the normal operation range is set to a range of 0.4 V to 4.8 V. When the outputs of the current sensors 241, 242 are outside the normal operation range (N in Sp2), the MCU 3 determines that the current sensors 241, 242 have failed (Sp15), and sets the active signal to the L-level (S20), and then the processing ends. When the outputs of the current sensors 241, 242 are within the normal operation range (Y in Sp2), the MCU 3 proceeds to Sp3.

In Sp3, the MCU 3 determines whether an output difference between the current sensors 241, 242 is within an allowable range. When the output difference between the current sensors 241, 242 exceeds the allowable range (N in Sp3), the MCU 3 determines that the current sensors 241, 242 have failed (Sp16), and sets the active signal to the L-level (Sp20), and then the processing ends. Next, when the output difference between the current sensors 241, 242 is within the allowable range (Y in Sp3), the MCU 3 proceeds to Sp4. In Sp4, the MCU 3 acquires a failure detection voltage and determines whether the acquired failure detection voltage is within an allowable range. At this time, as illustrated in the top row in FIG. 7, the MCU 3 outputs L-level forced interruption signals S32, S33, and the outputs of the current sensors 241, 242 are input to the overcurrent determination circuits 251, 252.

In Sp4, when no failure (abnormality) occurs in the current interruption circuit 2, the IPDs 231, 232 are turned off, and thus the failure detection voltage is an intermediate voltage (Mid) of 5 V. When an open abnormality in the resistor R11 of the overcurrent determination circuit 252, a short abnormality in the resistor R12 of the overcurrent determination circuit 252, a short abnormality in the IPD 232, or the like occur, the IPD 232 is turned on, and the failure detection voltage is 0 V (Low). Further, when an open abnormality in the resistor Rp occurs, the failure detection voltage is 5 V (High) even when the IPDs 231, 232 are turned off. When an open abnormality in the resistor R11 of the overcurrent determination circuit 251, a short abnormality in the resistor R12 of the overcurrent determination circuit 251, a short abnormality in the IPD 231, or the like occur, the IPD 231 is turned on, and the failure detection voltage is 5 V (High).

In Sp4, the MCU 3 determines that there is no failure when the failure detection voltage is within an allowable range that can be regarded as Mid, and determines that there is a failure when the failure detection voltage is outside the allowable range. When the failure detection voltage is outside the allowable range (N in Sp4), the MCU 3 determines that there is a circuit failure (Sp17), and sets the active signal to the L-level (Sp20), and then the processing ends.

When the failure detection voltage is within the allowable range (Y in Sp4), the MCU 3 outputs an H-level forced interruption signal S32 (Sp5). By this operation in Sp5, a discharge-side dummy voltage or a charge-side dummy voltage is supplied to the overcurrent determination circuit 251, and the output of the current sensor 242 is supplied to the overcurrent determination circuit 252. Next, the MCU 3 acquires a failure detection voltage and determines whether the acquired failure detection voltage is within the allowable range (Sp6).

A failure determination in Sp6 will be described with reference to FIG. 7. At this time, as illustrated in the second row from the top in FIG. 7, the MCU 3 outputs the H-level forced interruption signal S32 and the L-level forced interruption signal S33. In a case in which no failure (abnormality) occurs in the current interruption circuit 2, when the discharge-side dummy voltage or the charge-side dummy voltage is supplied, the overcurrent determination circuit 251 outputs an H-level overcurrent signal S11, and the IPD 231 is turned on. Since the IPD 232 is turned off, the failure detection voltage is 5 V (High). When an open abnormality in the IPD 231 or the like occurs, the IPD 231 cannot be turned on, and thus the failure detection voltage is an intermediate voltage (Mid) of 5 V. In addition, for example, when an open failure in the resistor R12 of the overcurrent determination circuit 251 and a short-circuit failure in the IPD 232 occur at the same time, the IPD 231 is turned off and the IPD 232 is turned on, and thus the failure detection voltage is 0 V (High).

In Sp6, the MCU 3 determines that there is no failure when the failure detection voltage is within an allowable range that can be regarded as High, and determines that there is a failure when the failure detection voltage is outside the allowable range. When the failure detection voltage is outside the allowable range (N in Sp6), the MCU 3 determines that there is a circuit failure (Sp18), and sets the active signal to the L-level (Sp20), and then the processing ends.

When the failure detection voltage is within the allowable range (Y in Sp6), the MCU 3 outputs an L-level forced interruption signal S32 (Sp7) and outputs an H-level forced interruption signal S33 (Sp8). By operations in Sp7 and Sp8, the discharge-side dummy voltage or the charge-side dummy voltage is supplied to the overcurrent determination circuit 252, and the output of the current sensor 241 is supplied to the overcurrent determination circuit 251. Next, the MCU 3 acquires a failure detection voltage and determines whether the acquired failure detection voltage is within the allowable range (Sp9).

A failure determination in S9 will be described with reference to FIG. 7. At this time, as illustrated in the third row from the top in FIG. 7, the MCU 3 outputs the H-level forced interruption signal S33 and the L-level forced interruption signal S32. In a case in which no failure (abnormality) occurs in the current interruption circuit 2, when the discharge-side dummy voltage or the charge-side dummy voltage is supplied, the overcurrent determination circuit 252 outputs an H-level overcurrent signal S12, and the IPD 232 is turned on. Since the IPD 231 is turned off, the failure detection voltage is 0 V (Low). When an open abnormality in the IPD 232 occurs, the IPD 232 cannot be turned on, and thus the failure detection voltage is an intermediate voltage (Mid) of 5 V. When an open abnormality in the resistor Rp occurs, the failure detection voltage is 5 V (High) even when the IPD 231 is off and the IPD 232 is off. In addition, for example, when an open failure in the resistor R12 of the overcurrent determination circuit 252 and a short-circuit failure in the IPD 231 occur at the same time, the IPD 231 is turned on and the IPD 232 is turned off, and thus the failure detection voltage is 5 V (High).

In Sp9, the MCU 3 determines that there is no failure when the failure detection voltage is within an allowable range that can be regarded as Low, and determines that there is a failure when the failure detection voltage is outside the allowable range. When the failure detection voltage is outside the allowable range (N in Sp9), the MCU 3 determines that there is a circuit failure (Sp19), and sets the active signal to the L-level (Sp20), and then the processing ends.

When the failure detection voltage is within the allowable range (Y in Sp9), the MCU 3 outputs an L-level forced interruption signal S33 (Sp10), and determines whether the overcurrent switching signal S31 has been switched (Sp11). If not switched (N in Sp11), the MCU 3 switches the overcurrent switching signal S31 from the H-level to the L-level or from the L-level to the H-level (S14). Accordingly, when Sp6 and Sp10 are first executed, one of the discharge-side dummy voltage and the charge-side dummy voltage is input to the overcurrent determination circuits 251, 252, and when Sp6 and Sp10 are executed after the switching, the other of the discharge-side dummy voltage and the charge-side dummy voltage is input to the overcurrent determination circuits 251, 252.

If switched (Y in Sp11), the MCU 3 switches the overcurrent switching signal S31 from the H-level to the L-level or from the L-level to the H-level (Sp12). Thereafter, the active signal is maintained at the H-level (Sp13), and the processing ends.

According to the above embodiment, since the failure determination circuit 28 can also determine a failure other than those in the current sensors 241, 242, erroneous determination of the overcurrent determination circuits 251, 252 can be reduced, and erroneous blowing of the ignition fuse can be reduced.

### Second Embodiment

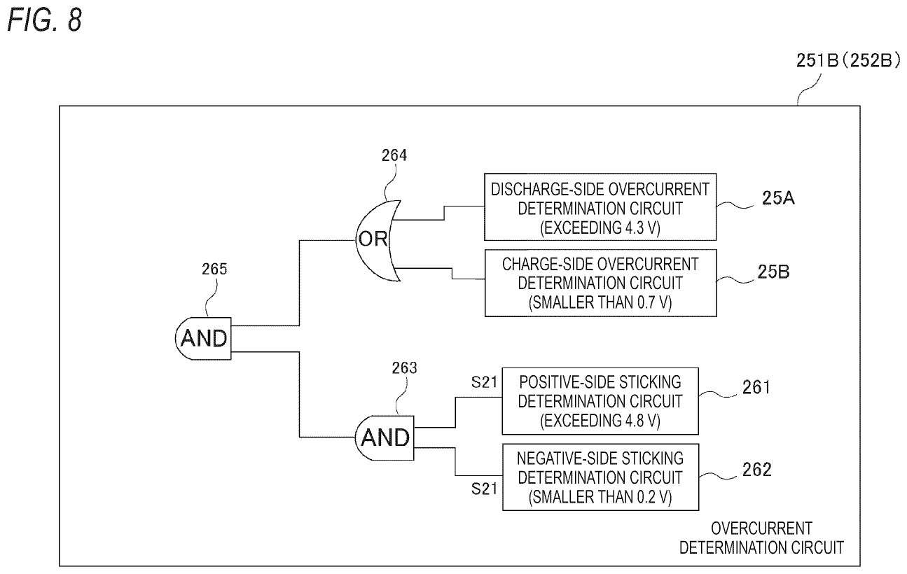

Next, a second embodiment will be described. A difference between the first embodiment and the second embodiment is configurations of overcurrent determination circuits 251B, 252B. As illustrated in FIG. 8, each of the overcurrent determination circuits 251B, 252B includes the discharge-side overcurrent determination circuit 25A, the charge-side overcurrent determination circuit 25B, a positive-side sticking determination circuit 261, a negative-side sticking determination circuit 262, an AND circuit 263, an OR circuit 264, and an AND circuit 265. The discharge-side overcurrent determination circuit 25A and the charge-side overcurrent determination circuit 25B are the same as those in the first embodiment.

As described above, the current sensors 241, 242 are clamped to the first clamp voltage (4.6 V) and the second clamp voltage (0.4 V) when a large current flows. On the other hand, when the current sensors 241, 242 fail, the current sensors 241, 242 stick to the first power supply voltage (5 V) and the second power supply voltage (0 V). Therefore, when the outputs of the current sensors 241, 242 exceed a third threshold (for example, 4.8 V) set between the first clamp voltage (4.6 V) and the first power supply voltage (5 V), the positive-side sticking determination circuit 261 determines that the current sensors 241, 242 have failed and outputs an L-level sticking signal S21. When the outputs of the current sensors 241, 242 are equal to or smaller than the third threshold (for example, 4.8 V), the positive-side sticking determination circuit 261 determines that the current sensors 241, 242 have not failed and outputs an H-level sticking signal S21. When the outputs of the current sensors 241, 242 are smaller than a fourth threshold (for example, 0.2 V) set between the second power supply voltage (0 V) and the second clamp voltage (0.4 V), the negative-side sticking determination circuit 261 determines that the current sensors 241, 242 have failed and outputs an L-level sticking signal S21. When the outputs of the current sensors 241, 242 are equal to or greater than the fourth threshold (for example, 0.2 V), the negative-side sticking determination circuit 261 determines that the current sensors 241, 242 have not failed and outputs an H-level sticking signal S21.

Outputs of the positive-side sticking determination circuit 261 and the negative-side sticking determination circuit 262 are input to the AND circuit 263. Outputs of the discharge-side overcurrent determination circuit 25A and the charge-side overcurrent determination circuit 25B are input to the OR circuit 264. Outputs of the OR circuit 264 and the AND circuit 263 are input to the AND circuit 265. The output of the AND circuit 263 is connected to inputs of the AND circuits 273, 274 illustrated in FIG. 1.

According to the overcurrent determination circuits 251B, 252B illustrated in FIG. 8, when at least one of the positive-side sticking determination circuit 261 and the negative-side sticking determination circuit 262 determines that there is a failure and outputs an L-level failure signal S21, the IPDs 231, 232 are not turned on (turned off) regardless of determination results of the discharge-side overcurrent determination circuit 25A and the charge-side overcurrent determination circuit 25B. That is, when at least one of the current sensors 241, 242 fails, both the IPDs 231, 232 are not turned on. Therefore, erroneous blowing of the ignition fuse can be reduced.

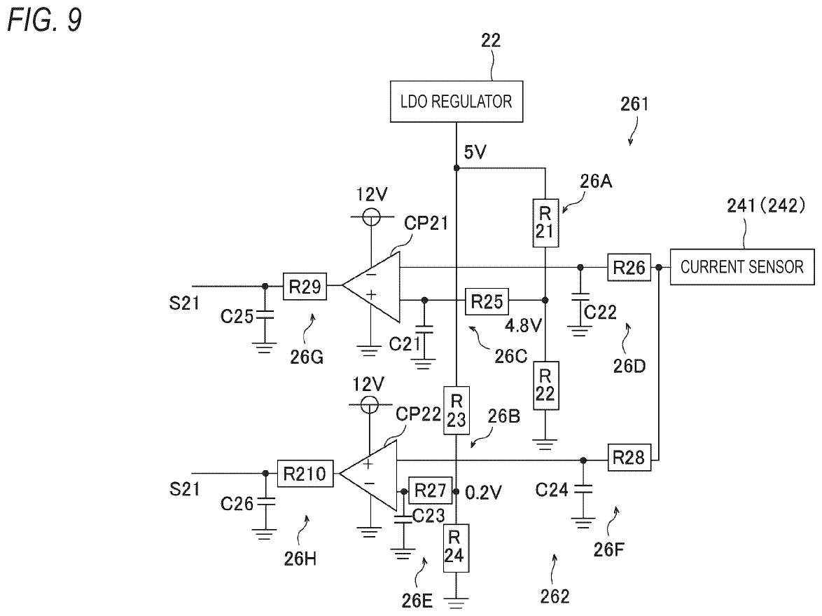

Next, details of the positive-side sticking determination circuit 261 and the negative-side sticking determination circuit 262 will be described with reference to FIG. 9. As illustrated in FIG. 9, the positive-side sticking determination circuit 261 includes a third threshold output circuit 26A, a comparator CP21, a low-pass filter 26C, a low-pass filter 26D, and a low-pass filter 26G. The negative-side sticking determination circuit 262 includes a fourth threshold output circuit 26B, a comparator CP22, a low-pass filter 26E, a low-pass filter 26F, and a low-pass filter 26H.

The third threshold output circuit 26A outputs a third threshold (4.8 V). The third threshold output circuit 26A includes resistors R21, R22 connected in series between the output of the LDO regulator 22 and ground. The third threshold output circuit 26A outputs a voltage obtained by dividing 5 V by the resistors R21, R22 as the third threshold (4.8 V).

The outputs of the current sensors 241, 242 are input to an inverting input of the comparator CP21 via the low-pass filter 26D, and the third threshold (4.8 V) is input to a non-inverting input of the comparator CP21 via the low-pass filter 26C. The comparator CP21 compares the outputs of the current sensors 241, 242 with the third threshold (4.8 V), and outputs an H-level signal when the outputs of the current sensors 241, 242 are smaller than the third threshold (4.8 V). The comparator CP21 outputs an L-level signal when the outputs of the current sensors 241, 242 are equal to or greater than the third threshold (4.8 V).

The fourth threshold output circuit 26B outputs a fourth threshold (0.2 V). The fourth threshold output circuit 26B includes resistors R23, R24 connected in series between the output of the LDO regulator 22 and ground. The fourth threshold output circuit 26B outputs a voltage obtained by dividing 5 V by the resistors R23, R24 as the fourth threshold (0.2 V).

The outputs of the current sensors 241, 242 are input to a non-inverting input of the comparator CP22 via the low-pass filter 26F, and the fourth threshold (0.2 V) is input to an inverting input of the comparator CP22 via the low-pass filter 26E. The comparator CP22 compares the output of the current sensor 241 with the fourth threshold (0.2 V), and outputs an H-level signal when the output of the current sensor 241 is greater than the fourth threshold (0.2 V). The comparator CP22 outputs an L-level signal when the output of the current sensor 241 is equal to or smaller than the fourth threshold (0.2 V).

The low-pass filter 26C is provided between the third threshold output circuit 26A and the comparator CP21. The low-pass filter 26C includes a resistor R25 connected between a connection point of the resistors R21, R22 and the inverting input of the comparator CP21, and a capacitor (capacitance) C21 connected between ground and a connection point of the resistor R25 and the comparator CP21. The low-pass filter 26C removes high-frequency noise at or above a cutoff frequency from an output of the third threshold output circuit 26A. Since the cutoff frequency is determined by values of the resistor R25 and the capacitor C21, the cutoff frequency is set within a range that does not sacrifice a response speed.

The low-pass filter 26D is provided between the current sensor 241 and the comparator CP21. The low-pass filter 26D includes a resistor R26 connected between the current sensor 241 and the inverting input of the comparator CP21, and a capacitor (capacitance) C22 connected between ground and a connection point of the resistor R26 and the comparator CP21. The low-pass filter 26D removes high-frequency noise at or above a cutoff frequency from the outputs of the current sensors 241, 242. Since the cutoff frequency is determined by values of the resistor R26 and the capacitor C22, the cutoff frequency is set within a range that does not sacrifice the response speed.

In the present embodiment, to prevent the third threshold (4.8 V) from falling earlier than the outputs of the current sensors 241, 242 when the LDO regulator 22 is powered off, the value of the capacitor C21 is set to be greater than the value of the capacitor C22.

The low-pass filter 26E is provided between the fourth threshold output circuit 26B and the comparator CP22. The low-pass filter 26E includes a resistor R27 connected between a connection point of the resistors R23, R24 and the inverting input of the comparator CP22, and a capacitor (capacitance) C23 connected between ground and a connection point of the resistor R27 and the comparator CP22. The low-pass filter 26E removes high-frequency noise at or above a cutoff frequency from an output of the fourth threshold output circuit 26B. Since the cutoff frequency is determined by values of the resistor R27 and the capacitor C23, the cutoff frequency is set within a range that does not sacrifice the response speed.

The low-pass filter 26F is provided between the current sensors 241, 242 and the comparator CP22. The low-pass filter 26F includes a resistor R28 connected between the current sensors 241, 242 and the non-inverting input of the comparator CP22, and a capacitor (capacitance) C24 connected between ground and a connection point of the resistor R28 and the comparator CP22. The low-pass filter 26F removes high-frequency noise at or above a cutoff frequency from the outputs of the current sensors 241, 242. Since the cutoff frequency is determined by values of the resistor R28 and the capacitor C24, the cutoff frequency is set within a range that does not sacrifice the response speed.

In the present embodiment, to prevent the output of the current sensor 241 from falling earlier than the fourth threshold (0.2 V) when the LDO regulator 22 is powered off, the value of the capacitor C24 is set to be greater than that of the capacitor C23.

The low-pass filter 26G is provided between an output of the comparator CP21 and the AND circuit 263. The low-pass filter 26G includes a resistor R29 connected between the comparator CP21 and an input of the AND circuit 263, and a capacitor (capacitance) C25 connected between ground and a connection point between the resistor R29 and the input of the AND circuit 263. The low-pass filter 26G removes high-frequency noise at or above a cutoff frequency from the output of the comparator CP21. Since the cutoff frequency is determined by values of the resistor R29 and the capacitor C25, the cutoff frequency is set within a range that does not sacrifice the response speed.

The low-pass filter 26H is provided between an output of the comparator CP22 and the AND circuit 263. The low-pass filter 26H includes a resistor R210 connected between the comparator CP22 and the input of the AND circuit 263, and a capacitor (capacitance) C26 connected between ground and a connection point between the resistor R210 and the input of the AND circuit 263. The low-pass filter 26H removes high-frequency noise at or above a cutoff frequency from the output of the comparator CP22. Since the cutoff frequency is determined by values of the resistor R210 and the capacitor C26, the cutoff frequency is set within a range that does not sacrifice the response speed.

The output of the comparator CP21 is input to the AND circuit 263 via the low-pass filter 26G, and the output of the comparator CP22 is input to the AND circuit 263 via the low-pass filter 26H. Therefore, when the outputs of the current sensors 241, 242 are greater than the third threshold (4.8 V) or smaller than the fourth threshold (0.2 V), the AND circuit 263 outputs an L-level sticking signal S21. When the output of the current sensor 241 is equal to or smaller than the third threshold (4.8 V) and equal to or greater than the fourth threshold (0.2 V), the AND circuit 263 outputs an H-level sticking signal S21.

### Third Embodiment

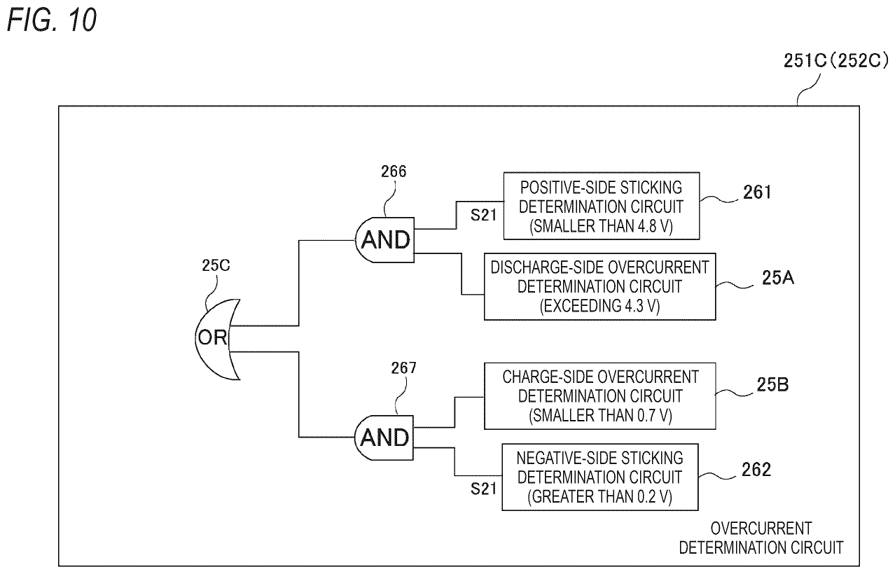

Next, a third embodiment will be described. A difference between the second embodiment and the third embodiment is configurations of overcurrent determination circuits 251C, 252C. As illustrated in FIG. 10, each of the overcurrent determination circuits 251C, 252C includes the discharge-side overcurrent determination circuit 25A, the charge-side overcurrent determination circuit 25B, the positive-side sticking determination circuit 261, the negative-side sticking determination circuit 262, AND circuits 266, 267, and the OR circuit 25C. The discharge-side overcurrent determination circuit 25A, the charge-side overcurrent determination circuit 25B, the positive-side sticking determination circuit 261, and the negative-side sticking determination circuit 262 are the same as those in the first embodiment.

Outputs of the positive-side sticking determination circuit 261 and the discharge-side overcurrent determination circuit 25A are input to the AND circuit 266. Outputs of the negative-side sticking determination circuit 262 and the charge-side overcurrent determination circuit 25B are input to the AND circuit 267. Outputs of the AND circuits 266, 267 are input to the OR circuit 25C. Also in this case, the same effect as those in the second embodiment can be obtained.

### Fourth Embodiment

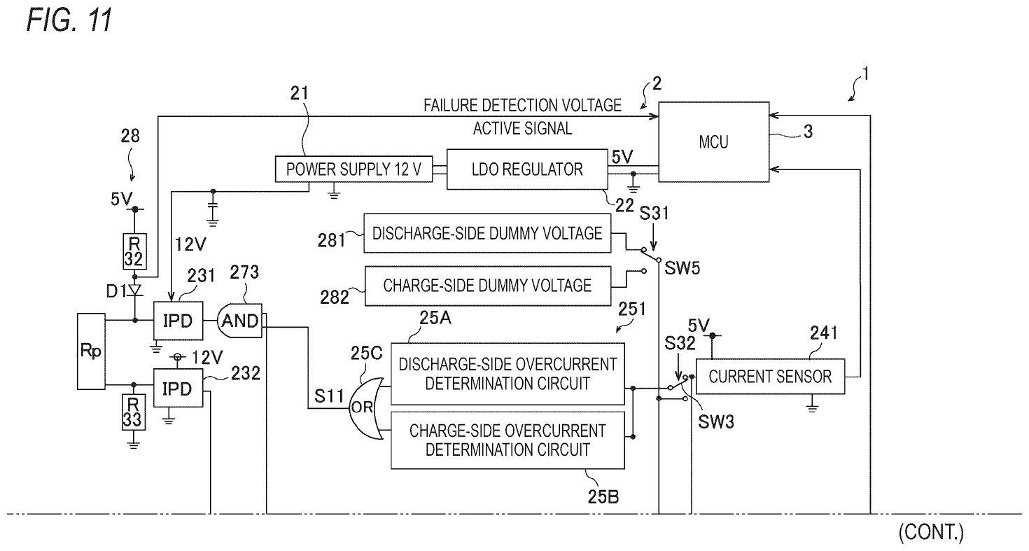

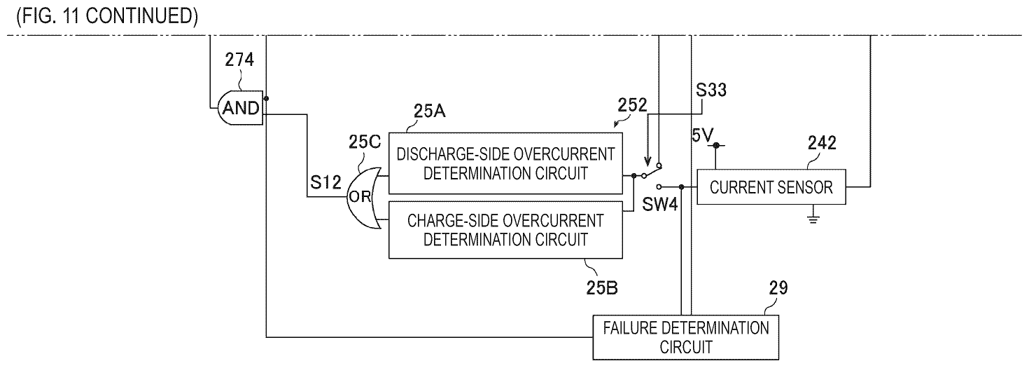

Next, a fourth embodiment will be described. A major difference between the first embodiment and the fourth embodiment is that a failure determination circuit 29 for the two current sensors 241, 242 is provided. As illustrated in FIG. 11, the failure determination circuit 29 is an analog circuit that determines whether the output difference between the two current sensors 241, 242 performed by the MCU 3 is within an allowable range. The failure determination circuit 29 may include a differential amplifier circuit that amplifies an output difference between the current sensors 241, 242 and a comparator that compares an output of the differential amplifier circuit with a threshold. An output of the failure determination circuit 29 is connected to the inputs of the AND circuits 273, 274. Accordingly, when the output difference between the current sensors 241, 242 is large and it is expected that one of the current sensors 241, 242 fails, the ignition fuse can be prevented from being blown, and erroneous blowing of the ignition fuse can be prevented.

The present disclosure is not limited to the above embodiments, and can be appropriately modified, improved, or the like. In addition, the materials, shapes, sizes, numbers, arrangement positions, and the like of the components in the above embodiments are freely selected and are not limited as long as the present disclosure can be implemented.

According to the above embodiment, the output of the current sensor 241 increases in response to an increase in current, and the output of the current sensor 242 decreases in response to an increase in current. However, the present disclosure is not limited thereto. The outputs of the current sensors 241, 242 may be changed in the same manner.

According to the above embodiment, the IPDs 231, 232 are adopted as the first switch and the second switch. However, the present disclosure is not limited thereto. Semiconductor switches such as field effect transistors (MOSFET) may be used as the first switch and the second switch.

According to the above embodiment, the voltage between the resistor R32 and the diode D1 is supplied to the MCU 3 as a failure detection voltage. However, the present disclosure is not limited thereto. The voltage between the resistor R33 and the resistor Rp may be supplied to the MCU 3 as a failure detection voltage, or the voltage between the diode D1 and the resistor Rp may be supplied to the MCU 3 as a failure detection voltage.

According to the above embodiment, the dummy voltage output circuits 281, 282 output both the discharge-side dummy voltage and the charge-side dummy voltage. However, the present disclosure is not limited thereto. Only the discharge-side dummy voltage output circuit 281 may be provided so that only the discharge-side dummy voltage can be output. Alternatively, only the charge-side dummy voltage output circuit 282 may be provided so that only the charge-side dummy voltage can be output.

The above dummy voltage may be varied under the control of the MCU 3.

Here, features of the current interruption circuit and the current interruption system according to the above embodiments of the present disclosure will be briefly summarized and listed in [1] to [8] below, respectively.

[1]

A current interruption circuit (2) including:
a first switch (231) and a second switch (232) provided on both sides of a first resistor (Rp), which is enclosed within an ignition fuse and is burned out due to heat upon ignition, the first resistor (Rp) being energized when both switches are turned on;
a first current sensor (241) and a second current sensor (242) configured to detect a current in a current path in which the ignition fuse is provided;
a first overcurrent determination circuit (251) configured to determine an overcurrent based on an output of the first current sensor (241); and
a second overcurrent determination circuit (252) configured to determine an overcurrent based on an output of the second current sensor (242), in which
the first switch (231) is turned on based on a determination result of the first overcurrent determination circuit (251), and
the second switch (232) is turned on based on a determination result of the second overcurrent determination circuit (252).

With the configuration according to the above [1], by energizing the first resistor (Rp) only when both the first and second overcurrent determination circuits (251, 252) determine an overcurrent, the ignition fuse can be accurately blown when the overcurrent occurs, and erroneous blowing of the ignition fuse in a normal state, in which no overcurrent occurs, can be reduced.

[2]

The current interruption circuit (2) according to [1], further including:
a failure determination circuit (29) configured to determine failures of the first current sensor (241) and the second current sensor (242) based on an output difference between the first current sensor (241) and the second current sensor (242), in which
the first switch (231) and the second switch (232) are not turned on while the failure determination circuit (29) is determining a failure.

With the configuration according to the above [2], when at least one of the first and second current sensors (241, 242) fails, both the first and second switches (231, 232) are not turned on. Therefore, erroneous blowing of the ignition fuse can be reduced.

[3]

The current interruption circuit (2) according to [1], in which
the first switch (231), the second switch (232), the first overcurrent determination circuit (251), and the second overcurrent determination circuit (252) are mounted on a substrate (246) on which the first current sensor (241) and the second current sensor (242) are mounted.

With the configuration according to the above [3], there is no need to separately provide a substrate for the first and second current sensors (241, 242) and a substrate for the first and second switches (231, 232) and the first and second overcurrent determination circuits (251, 252), and the number of components and size can be reduced.

[4]

The current interruption circuit (2) according to [1], in which
an output of the first current sensor (241) increases in response to an increase in current flowing through the current path, and
an output of the second current sensor (242) decreases in response to an increase in current flowing through the current path.

With the configuration according to the above [4], even if noise from the same noise source is superimposed on the outputs of the first and second current sensors (241, 242), the ways in which the noise is superimposed are different. Therefore, even if one of the first and second overcurrent determination circuits (251, 252) determines an overcurrent due to noise, it is highly likely that the other does not determine an overcurrent, and thus erroneous blowing of the fuse can be reduced.

[5]

The current interruption circuit (2) according to [1], in which
each of the first overcurrent determination circuit (251) and the second overcurrent determination circuit (252) includes
   a first threshold output circuit (25A-1) that outputs a first threshold,
   a first comparator (CP11) that compares the first threshold with an output of the first current sensor (241) or the second current sensor (242),
   a second threshold output circuit (25B-1) that outputs a second threshold smaller than the first threshold,
   a second comparator (CP12) that compares the second threshold with an output of the first current sensor (241) or the second current sensor (242),
   a first low-pass filter (25A-2) provided between the first threshold output circuit (25A-1) and the first comparator (CP11),
   a second low-pass filter (25A-3) provided between the first current sensor (241) or the second current sensor (242) and the first comparator (CP11),
   a third low-pass filter (25B-2) provided between the second threshold output circuit (25B-1) and the second comparator (CP12), and
   a fourth low-pass filter (25B-3) provided between the first current sensor (241) or the second current sensor (242) and the second comparator (CP12), and
   a capacitance of the first low-pass filter (25A-2) is set to be greater than a capacitance of the second low-pass filter (25A-3), and
   a capacitance of the fourth low-pass filter (25B-3) is set to be greater than a capacitance of the third low-pass filter (25B-2).

With the configuration according to the above [5], when the first and second threshold output circuits (25A-1, 25B-1) are powered off, erroneous determinations by the first and second overcurrent determination circuits (251, 252) can be reduced, and erroneous blowing of the fuse can be reduced.

[6]

The current interruption circuit (2) according to [1], further including:
a second resistor (R32) and a diode (D1) connected in series between a first power supply voltage (5V) and a connection point of the first resistor (Rp) and the first switch (231);
a third resistor (R33) connected between a second power supply voltage and a connection point of the first resistor (Rp) and the second switch (232);
a dummy voltage output circuit (281, 282) configured to output a dummy voltage corresponding to an overcurrent;
a third switch (SW3) configured to switch an input to the first overcurrent determination circuit (251) between the output of the first current sensor (241) and the dummy voltage output by the dummy voltage output circuit (281, 282); and
a fourth switch (SW4) configured to switch an input to the second overcurrent determination circuit (252) between the output of the second current sensor (242) and the dummy voltage output by the dummy voltage output circuit (281, 282).

With the configuration according to the above [6], a dummy voltage can be input to the first and second overcurrent determination circuits (251, 252), and a failure of the current interruption circuit (2) can be determined based on a voltage between the second resistor (R32) and the first resistor (Rp) or a voltage between the third resistor (R33) and the first resistor (Rp).

[7]

A current interruption system (1) including:
the current interruption circuit (2) according to [6]; and
a controller (3) configured to determine a failure based on a voltage between the second resistor (R32) and the first resistor (Rp) or a voltage between the third resistor (R33) and the first resistor (Rp), in each case in which the third switch (SW3) is switched to a first current sensor (241) side and the fourth switch (SW4) is switched to a second current sensor (242) side, or the third switch (SW3) is switched to a dummy voltage output circuit (281, 282) side and the fourth switch (SW4) is switched to the second current sensor (242) side, or the third switch (SW3) is switched to the first current sensor (241) side and the fourth switch (SW4) is switched to the dummy voltage output circuit (281, 282) side.

With the configuration according to the above [7], a failure of the current interruption circuit (2) can be determined by the controller (3).

[8]
A current interruption system (1) including:
the current interruption circuit (2) according to [1]; and
a controller (3) configured to turn on an active signal, in which
the first switch (231) and the second switch (232) are not turned on while the active signal is off.

With the configuration according to the above [8], for example, after the power is turned on, the active signal is turned off for a certain period until the power is stable, so that the first and second switches (231, 232) are not turned off during that period. Therefore, erroneous determinations by the first and second overcurrent determination circuits (251, 252) can be reduced, and erroneous blowing of the fuse can be reduced.

What is claimed is:

1. A current interruption circuit comprising:
a first switch and a second switch provided on both sides of a first resistor, which is enclosed within an ignition fuse and is burned out due to heat upon ignition, the first resistor being energized when both switches are turned on;
a first current sensor and a second current sensor configured to detect a current in a current path in which the ignition fuse is provided;
a first overcurrent determination circuit configured to determine an overcurrent based on an output of the first current sensor; and
a second overcurrent determination circuit configured to determine an overcurrent based on an output of the second current sensor, wherein
the first switch is configured to be turned on based on a determination result of the first overcurrent determination circuit, and
the second switch is configured to be turned on based on a determination result of the second overcurrent determination circuit.

2. The current interruption circuit according to claim 1, further comprising:
a failure determination circuit configured to determine failures of the first current sensor and the second current sensor based on an output difference between the first current sensor and the second current sensor, wherein
the first switch and the second switch are configured to not be turned on while the failure determination circuit is determining a failure.

3. The current interruption circuit according to claim 1, wherein
the first switch, the second switch, the first overcurrent determination circuit, and the second overcurrent determination circuit are mounted on a substrate on which the first current sensor and the second current sensor are mounted.

4. The current interruption circuit according to claim 1, wherein
an output of the first current sensor is configured to increase in response to an increase in current flowing through the current path, and
an output of the second current sensor is configured to decrease in response to an increase in current flowing through the current path.

5. The current interruption circuit according to claim 1, wherein
each of the first overcurrent determination circuit and the second overcurrent determination circuit includes
a first threshold output circuit that outputs a first threshold,
a first comparator that compares the first threshold with an output of the first current sensor or the second current sensor,
a second threshold output circuit that outputs a second threshold smaller than the first threshold,
a second comparator that compares the second threshold with an output of the first current sensor or the second current sensor,
a first low-pass filter provided between the first threshold output circuit and the first comparator,
a second low-pass filter provided between the first current sensor or the second current sensor and the first comparator,
a third low-pass filter provided between the second threshold output circuit and the second comparator, and
a fourth low-pass filter provided between the first current sensor or the second current sensor and the second comparator, and
a capacitance of the first low-pass filter is set to be greater than a capacitance of the second low-pass filter, and
a capacitance of the fourth low-pass filter is set to be greater than a capacitance of the third low-pass filter.

6. The current interruption circuit according to claim 1, further comprising:
a second resistor and a diode connected in series between a first power supply voltage and a connection point of the first resistor and the first switch;
a third resistor connected between a second power supply voltage and a connection point of the first resistor and the second switch;
a dummy voltage output circuit configured to output a dummy voltage corresponding to an overcurrent;
a third switch configured to switch an input to the first overcurrent determination circuit between the output of the first current sensor and the dummy voltage output by the dummy voltage output circuit; and
a fourth switch configured to switch an input to the second overcurrent determination circuit between the output of the second current sensor and the dummy voltage output by the dummy voltage output circuit.

7. A current interruption system comprising:
the current interruption circuit according to claim 6; and
a controller configured to determine a failure based on a voltage between the second resistor and the first resistor or a voltage between the third resistor and the first resistor, in each case in which the third switch is switched to a first current sensor side and the fourth switch is switched to a second current sensor side, or the third switch is switched to a dummy voltage output circuit side and the fourth switch is switched to the second current sensor side, or the third switch is switched to the first current sensor side and the fourth switch is switched to the dummy voltage output circuit side.

8. A current interruption system comprising:
the current interruption circuit according to claim 1; and
a controller configured to turn on an active signal, wherein
the first switch and the second switch are configured to not be turned on while the active signal is off.
